(19) United States
(12) Patent Application Publication
(10) Pub. No.: US 2011/0162362 A1
(43) Pub. Date: Jul. 7, 2011

(54) MULTIPLE HEAT ENGINE POWER GENERATION SYSTEM

(75) Inventor: Thomas W. Steiner, Burnaby (CA)

(73) Assignee: Etalim Inc., Burnaby (CA)

(21) Appl. No.: 13/062,493

(22) PCT Filed: Sep. 4, 2008
(86) PCT No.: PCT/US08/75283

§ 371 Date: Mar. 4, 2011

(51) Int. Cl. F03G 6/00; F01K 27/00; F01K 23/06; F01B 29/08; F01K 13/00

(52) U.S. Cl. 60/641.15; 60/643; 60/670; 60/516; 60/645

(57) ABSTRACT

A power generation system includes a heat source, a primary heat engine and a secondary heat engine. The primary heat engine has a hot heat exchanger thermally coupled to the heat source and a cold heat exchanger. The secondary heat engine has a hot heat exchanger thermally coupled to the cold heat exchanger of the primary heat engine and a cold heat exchanger configured to reject waste heat.

### CROSS-REFERENCE TO RELATED APPLICATION

This application is a U.S. national stage application filed under 35 U.S.C. §371 of International Patent Application PCT/US2008/075283, accorded an international filing date of Sep. 4, 2008, which is incorporated herein by reference in its entirety.

### BACKGROUND

1. Technical Field

This description generally relates to the field of electricity generation, and more particularly to generating electricity using multiple heat engines.

2. Description of the Related Art

There are a variety of power systems that may be used to generate electricity from a thermal gradient. The thermal gradient utilized by such power systems may be generated in a variety of ways, such as by chemical processes, solar collection, geothermal activity, nuclear power, etc. Concentrating solar power (“CSP”) systems have become one of the leading contenders for utility scale deployment of renewable electricity generation capacity.

There are three distinct versions of CSP systems. One CSP system includes a parabolic trough in which an array of 1-axis sun tracking troughs focus sunlight on one or more heater tubes at a linear focus of the parabolic trough. A fluid passing through the heater tubes transports the heat generated at the linear focus to a central power plant housing a conventional heat engine and generator. Another CSP system is a central receiver type, wherein a fluid is heated at a central tower, which is at the focus of an array of sun tracking heliostats. The heat from the fluid is then transferred to a central heat engine. The third CSP system includes an array of concentrators with a heat engine (e.g., a Stirling engine) at the focus of each one. This type of system provides a smaller heat engine at each concentrator, rather than employing a single centralized heat engine. Similar power generation systems may be used with a variety of heat sources.

It would be desirable to obtain a power generation system with improved efficiency and flexibility.

### BRIEF SUMMARY

In one embodiment, a power generation system is disclosed. The power generation system comprises: a heat source; at least one primary heat engine operating between a high temperature generated by the heat source and an intermediate temperature; and at least one secondary heat engine thermally coupled to the at least one primary heat engine, and operating between approximately the intermediate temperature and a low temperature for rejection of waste heat.

In another embodiment, another power generation system is disclosed. The power generation system comprises: a heat source; at least one primary heat engine operating between a high temperature generated by the heat source and an intermediate temperature; a thermal energy storage system thermally coupled to the at least one primary heat engine, the thermal energy storage system configured to store thermal energy; and at least one secondary heat engine thermally coupled to the thermal energy storage system, and operating between approximately the intermediate temperature and a low temperature for rejection of waste heat.

In another embodiment, another power generation system is disclosed. The power generation system comprises: a heat source; a primary heat engine having a hot heat exchanger thermally coupled to the heat source, and a cold heat exchanger; and a secondary heat engine having a hot heat exchanger thermally coupled to the cold heat exchanger of the primary heat engine, and a cold heat exchanger configured to reject waste heat.

In another embodiment, another power generation system is disclosed. The power generation system comprises: a heat source; a primary heat engine having a hot heat exchanger thermally coupled to the heat source, and a cold heat exchanger; a thermal energy storage system thermally coupled to the cold heat exchanger of the primary heat engine; and a secondary heat engine having a hot heat exchanger thermally coupled to the thermal energy storage system, and a cold heat exchanger configured to reject waste heat.

In yet another embodiment, another power generation system is disclosed. The power generation system comprises: a plurality of heat sources; a plurality of primary heat engines, each primary heat engine having a hot heat exchanger thermally coupled to a corresponding one of the plurality of heat sources, and a cold heat exchanger; and a secondary heat engine having a hot heat exchanger thermally coupled to the plurality of primary heat engines, and a cold heat exchanger configured to reject waste heat. In one embodiment, this power generation system may further include a thermal energy storage system thermally coupled between the cold heat exchanger of each of the plurality of primary heat engines, and the hot heat exchanger of the secondary heat engine.

In another embodiment, a method of generating power is disclosed, the method comprising: heating a primary heat engine using a heat source; generating power at the primary heat engine; storing thermal energy provided at least in part by heat rejected from the primary heat engine; heating a secondary heat engine using the stored thermal energy; and generating power at the secondary heat engine.

In another embodiment, another method of generating power is disclosed, the method comprising: heating a primary heat engine using a heat source; generating power at the primary heat engine; heating a secondary heat engine using thermal energy provided at least in part by heat rejected from the primary heat engine; and generating power at the secondary heat engine.

In still another embodiment, another method of generating power is disclosed, the method comprising: heating a plurality of primary heat engines using a corresponding plurality of heat sources; generating power at the plurality of primary heat engines; heating a secondary heat engine using thermal energy provided at least in part by heat rejected from each of the plurality of primary heat engines; and generating power at the secondary heat engine. In one embodiment, this method may further include storing the thermal energy provided at least in part by the heat rejected from the plurality of primary heat engines.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a thermodynamic, schematic view of an exemplary power generation system including two heat engines thermally coupled in series by a heat transfer loop, according to one illustrated embodiment.

FIG. 2 is a schematic view of an exemplary power generation system including two heat engines, according to one illustrated embodiment.

FIG. 3 is a schematic view of another exemplary power generation system including two heat engines, according to one illustrated embodiment.

FIG. 4 is a schematic view of yet another exemplary power generation system including two heat engines and a thermal energy storage system, according to one illustrated embodiment.

FIG. 5 is a schematic view of another exemplary power generation system including a plurality of heat engines and a thermal energy storage system, according to one illustrated embodiment.

FIG. 6 is a flow diagram illustrating a method of generating power, according to one illustrated embodiment.

FIG. 7 is a flow diagram illustrating another method of generating power, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and methods associated with heat engines (e.g., Stirling engines), electricity and power generation, solar collectors, and thermal storage and transport have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Example Power Generation System

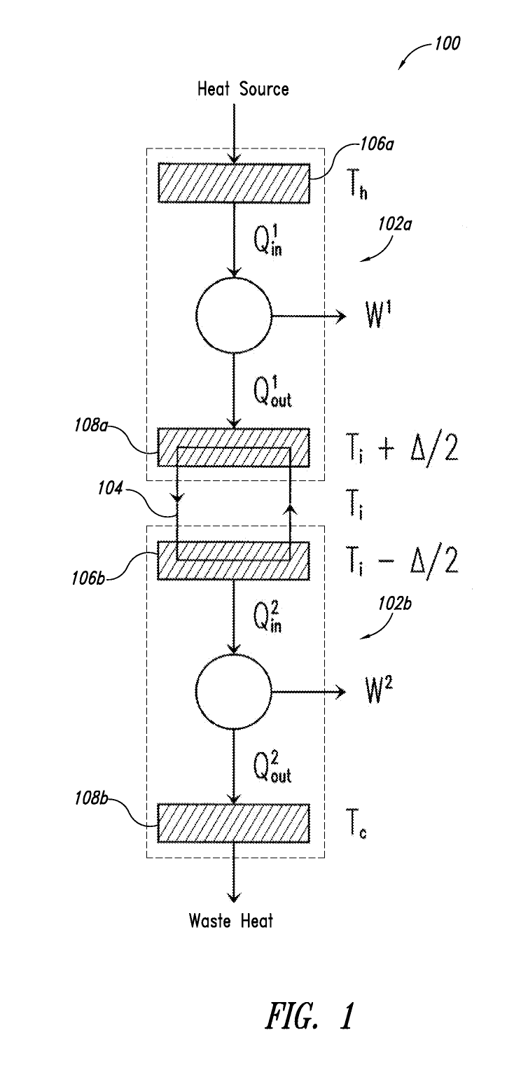

FIG. 1 is a thermodynamic, schematic view of an exemplary power generation system 100 including at least one primary heat engine 102a and at least one secondary heat engine 102b (collectively 102) thermally coupled in series by a heat transfer loop 104. The power generation system 100 may comprise any of a variety of power generation systems and may accept heat from a variety of heat sources. In one embodiment, the power generation system 100 is a concentrating solar power (“CSP”) system, and the heat source includes one or more mirrors and/or lenses configured to concentrate sunlight at a focal point. In another embodiment, the power generation system 100 is a geothermal system, and the heat source includes geothermal activity that generates heat for the power generation system 100. In yet another embodiment, the power generation system 100 uses a fuel (e.g., a chemical, biological or nuclear fuel) that combusts, fuses, or otherwise generates heat. In still other embodiments, the power generation system 100 may take advantage of a combination of heat sources used at the same or at different times.

As illustrated, the power generation system 100 comprises a primary heat engine 102a thermally coupled to the heat source, and a secondary heat engine 102b thermally coupled to the primary heat engine 102a. In other embodiments, the power generation system 100 may comprise more than two heat engines. For example, the power generation system 100 may comprise three or more heat engines coupled in series, with each heat engine thermally coupled to one or more other heat engines. Moreover, the power generation system 100 may also comprise more heat engines coupled in parallel. That is, in one exemplary configuration, the power generation system 100 may include two or more primary heat engines thermally coupled to corresponding heat sources, and each of those primary heat engines may be thermally coupled to the secondary heat engine 102b. In another embodiment, the power generation system 100 may include two or more secondary heat engines thermally coupled to the primary heat engine 102a.

The heat engines 102 may comprise any of a variety of heat engines, and they may comprise engines of the same or different type. As used herein, the term “heat engine” may be used to refer to any engine that converts heat to mechanical motion. In one embodiment, the heat engines 102 may comprise Stirling heat engines. In other embodiments, heat engines employing other heat cycles may be used in the power generation system 100. For example, the secondary heat engine 102b may comprise a steam turbine.

The primary heat engine 102a may operate between a high temperature Tₕ and approximately an intermediate temperature Tᵢ. As illustrated, a hot heat exchanger 106a of the primary heat engine 102a may be thermally coupled to the heat source, and the high temperature Tₕ may be reached at this hot heat exchanger 106a. In one embodiment, the hot heat exchanger 106a may comprise a heat absorbent material at a focal point of a CSP array. In other embodiments, the heat source may warm a liquid or other heat transfer medium (not shown), which may, in turn, be transported to the hot heat exchanger 106a. Based on the heat absorbed Qᵢₙ¹ and the heat dumped Qₒᵤₜ¹, the primary heat engine 102a may produce a certain amount of work W¹. The cold heat exchanger 108a of the primary heat engine 102a may be thermally coupled to the heat transfer loop 104, as illustrated. In one embodiment, the cold heat exchanger 108a rejects heat at an intermediate temperature Tᵢ of the heat transfer loop 104 plus a relatively small temperature delta (Tᵢ+λ/2). It may be understood that every heat exchange may involve a drop in temperature, and therefore the cold heat exchanger 108a may reject its heat at a temperature slightly higher than the temperature of the heat transfer loop 104.

The secondary heat engine 102b may operate between approximately the intermediate temperature Tᵢ and a low temperature T_{c} for the rejection of waste heat. A hot heat exchanger 106b of the secondary heat engine 102b may be thermally coupled to the heat transfer loop 104, which may be carrying a heat transfer liquid or another heat transfer medium at approximately an intermediate temperature Tᵢ. As described above, every heat exchange may involve a drop in temperature, and therefore, the hot heat exchanger 106b may reach the intermediate temperature Tᵢ of the heat transfer loop 104 minus a relatively small temperature delta (Tᵢ−λ/2). Although the temperature delta at the hot heat exchanger 106b is illustrated as being the same as the temperature delta at the cold heat exchanger 108a, in different embodiments, these temperature deltas may differ from one another.

In one embodiment, the hot heat exchanger 106b may comprise any of a variety of heat exchangers thermally coupled to the heat transfer loop 104. Based on the heat absorbed Qᵢₙ² and the heat dumped Qₒᵤₜ² the secondary heat engine 102b may produce a certain amount of work W². The cold heat exchanger 108b of the secondary heat engine 102b may be configured to reject waste heat, as illustrated. In one embodiment, the cold heat exchanger 108b rejects heat at a relatively low temperature T_{c}, which may correspond to an ambient temperature or even to a colder temperature to increase a temperature difference between the hot and cold heat exchangers 106b, 108b of the secondary heat engine 102b. In one embodiment, the cold heat exchanger 108b may include a plurality of cooling fins, or other structures for improving the cooling efficiency of the secondary heat engine 102b.

The heat transfer loop 104 may be configured to transfer heat between the cold heat exchanger 108a of the primary heat engine 102a, and the hot heat exchanger 106b of the secondary heat engine 102b. In one embodiment, the heat transfer loop 104 comprises piping or other structures for transporting a heat transfer fluid between the cold heat exchanger 108a and the hot heat exchanger 106b. In one embodiment, the heat transfer fluid may comprise molten salt or oil. In other embodiments, other fluids with a relatively high heat capacity may be used. In another embodiment, the heat transfer loop 104 may comprise a heat pipe system for otherwise transporting heat (e.g., via a latent heat of a working fluid in the heat transfer loop 104).

Turning to an analysis of the thermodynamics of these heat engines 102 coupled in series, the maximum theoretical efficiency of any heat engine operating between a heat reservoir at a hot temperature Tₕ and a colder heat reservoir at a cold temperature T_{c} is the Carnot efficiency:

$${η}_{c} = \frac{{T}_{h} - {T}_{c}}{{T}_{h}}$$

Of course, real heat engines will operate at a fraction of this efficiency. Some Stirling engines, for example, have achieved efficiencies near 70% of the Carnot efficiency.

In one embodiment, the two heat engines 102 working in series may actually be more efficient than a single heat engine operating between the same temperature difference, provided each of the heat engines has the same efficiency. For example, in one embodiment, each of the two heat engines 102 operates at 70% of the Carnot efficiency, the hot temperature Tₕ is 1200K, the intermediate temperature Tᵢ is 600K, and the cold reservoir temperature T_{c} is 300K. In such an embodiment, the Carnot efficiency (i.e., the maximum theoretical efficiency) for each of the two heat engines 102 is 50%, since the temperature difference is, for each engine 102, a factor of two. Each heat engine 102 may function at 70% of the Carnot efficiency, and thus each engine 102 may be 35% efficient in its conversion of input heat to mechanical motion. However, the combined efficiency of both engines 102 together is not 70% in this theoretical analysis. Since the secondary heat engine 102b has its heat input reduced by an amount converted to mechanical motion by the primary heat engine 102a, the theoretical heat input to the secondary heat engine 102b is Qᵢₙ²=Qᵢₙ¹−W¹=Qᵢₙ¹−0.35·Qᵢₙ¹=0.65·Qᵢₙ¹. The heat input energy to the secondary heat engine 102b may therefore be only 65% of what is supplied to the primary heat engine 102a. Since both engines 102 have the same efficiency in this embodiment, the mechanical output of the secondary heat engine 102b may be 65% of the mechanical output of the primary heat engine 102a. Thus, the secondary heat engine 102b may convert an additional 23% of the initial heat input to the primary heat engine 102a to mechanical motion (i.e., 0.65*0.35). Thus, the combined theoretical efficiency of both engines may be approximately 58%.

In comparison, a single Carnot engine operating between the high temperature Tₕ of 1200K and the cold temperature T_{c} of 300K would have an efficiency of 75%. Thus, a heat engine operating at 70% of the Carnot efficiency might achieve 52.5% efficiency. In this embodiment, the output of the two engines 102 in series may be greater than the output of the hypothetical single heat engine by about 5%. This embodiment illustrates how two real heat engines in series may outperform a single real heat engine.

Of course, other factors may narrow a performance gap between the heat engines 102 coupled in series and a single, comparable heat engine. As described above, every heat exchange involves a drop in temperature, and the series configuration of FIG. 1 has two additional heat exchange steps beyond those required for a single heat engine. That is, the cold heat exchanger 108a of the primary heat engine 102a transfers rejected heat to the heat transfer loop 104, and heat transfer fluid in the heat transfer loop 104 then transfers heat to the hot heat exchanger 106b of the secondary heat engine 102b. As described above, the primary heat engine 102a therefore rejects heat at a temperature Tᵢ+λ/2 slightly higher than the intermediate temperature Tᵢ of the heat transfer loop 104. Similarly, the heat input at the hot heat exchanger 106b of the secondary heat engine 102b is at a temperature Tᵢ−λ/2 slightly lower than the intermediate temperature T. These small temperature differences may reduce the efficiency of the series combination. In the embodiment described above, however, the total temperature delta, Δ, between the two engines 102 would need to be approximately 125 K before the theoretical performance of the heat engines 102 coupled in series drops to the level of a single heat engine. Given particular heat exchange geometries, it may be possible to achieve heat transfer via the heat transfer loop 104 without exceeding this temperature delta.

In some embodiments, given less than perfect thermal insulation, there may also be conduction losses from the heat transfer loop 104 to the ambient environment. These losses may scale with the length of the heat transfer loop 104 and may favor the use of shorter heat transfer loops. This factor may also narrow the performance gap between the heat engines 102 coupled in series and a single heat engine. However, this factor may be mitigated with shorter, better insulated heat transfer loops.

Thus, the power generation system 100 with the heat engines 102 coupled in series may not suffer a performance penalty in comparison to a single engine and may, in some embodiments, even perform better.

Of course, the precise temperatures for the high temperature Tₕ, intermediate temperature Tᵢ, and cold temperature T_{c} used above were selected for convenience only. Different temperatures may be appropriate for different implementations utilizing different heat sources and heat engines. For example, the cold temperature T_{c} at the cold heat exchanger 108b of the secondary heat engine 102b may be higher than 300K. In other embodiments, the heat engines may have high temperature limitations. For example, the hot heat exchanger 106a of the primary heat engine 102a may be limited to temperatures of less than 1100K based on the materials used in the primary heat engine 102a. Such differences in the temperatures may, of course, reduce the overall efficiency of the power generation system 100 to values lower than those set forth above with reference to the exemplary embodiment.

The intermediate temperature Tᵢ may be selected based on a variety of considerations. Higher intermediate temperatures may result in a larger fraction of power generated by the secondary heat engine 102b. In the embodiment discussed above, the primary heat engine 102a generates more than half of the power generated by the power generation system 100, as it processes a larger quantity of heat. By increasing the intermediate temperature Tᵢ, an output of the secondary heat engine 102b can be increased while reducing the output of the primary heat engine 102a. Moreover, as described in greater detail below, when employing a thermal energy storage system coupled to the secondary heat engine 102b, a greater fraction of the total output of the power generation system 100 may be made dispatchable if higher intermediate temperatures Tᵢ are used. On the other hand, increasing the intermediate temperature Tᵢ may increase losses associated with transporting and storing the thermal energy, and may also increase the cost and complexity of designing the heat transfer loop 104 to tolerate the desired intermediate temperature Tᵢ.

### Description of Another Example Power Generation System

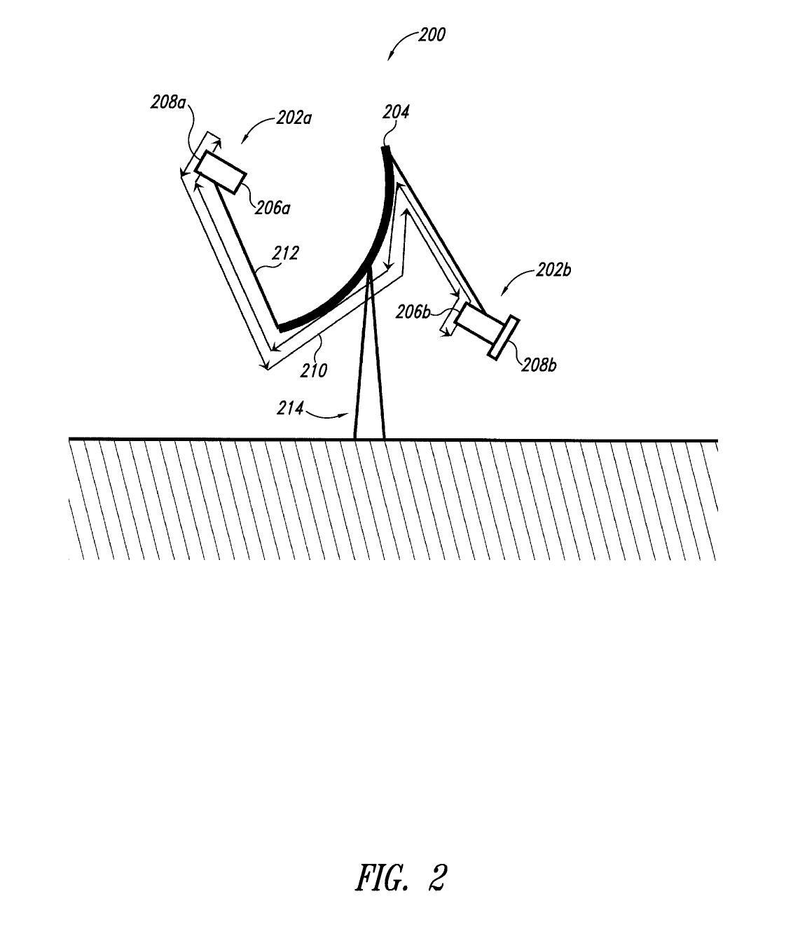

FIG. 2 is a schematic view of another exemplary power generation system 200 including a primary heat engine 202a and a secondary heat engine 202b. As illustrated, the power generation system 200 includes a solar concentrator 204 (e.g., a solar concentrating dish) for focusing incident sunlight onto a hot heat exchanger 206a of the primary heat engine 202a. A cold heat exchanger 208a of the primary heat engine 202a may, in turn, be thermally coupled to a hot heat exchanger 206b of the secondary heat engine 202b via a heat transfer loop 210. A cold heat exchanger 208b of the secondary heat engine 202b may be configured to reject waste heat to the ambient environment.

The solar concentrator 204 may comprise any of a variety of mirror and/or lens systems for focusing incident sunlight. In one embodiment, the solar concentrator 204 may comprise one or more mirrors and/or lenses configured to focus sunlight onto the hot heat exchanger 206a of the primary heat engine 202a. The entire solar concentrator 204 may be moveable in order to track a path of the sun through the sky. In some embodiments, a plurality of mirrors and/or lenses may be independently moveable to ensure that the sunlight is accurately focused. In another embodiment, the solar concentrator 204 may comprise a solar concentrating dish having a continuous mirrored surface configured to focus sunlight onto the hot heat exchanger 206a.

In one embodiment, the power generation system 200 may comprise a plurality of solar concentrators configured similarly to the solar concentrator 204 with associated heat engines 202a, 202b. For example, the power generation system 200 may include a sufficient number of solar concentrators to deliver substantial amounts of electrical power. In other embodiments, the power generation system 200 may comprise a heterogeneous mix of power sources, and the solar concentrator 204 and associated heat engines 202a, 202b may be only one of those sources.

As illustrated, the power generation system 200 comprises two heat engines 202a, 202b coupled in series. Of course, in other embodiments, the power generation system 200 may comprise more than two heat engines. For example, the power generation system 200 may comprise two heat engines coupled in series near the focal point of the solar concentrator 204, with a third heat engine located some distance from the focal point of the solar concentrator 204. In another embodiment, the power generation system 200 may comprise two or more heat engines coupled in series or parallel positioned some distance from the focal point of the solar concentrator 204, with a single primary heat engine 202a located at the focal point.

As described above, the hot heat exchanger 206a of the primary heat engine 202a may be thermally coupled to the heat source, which comprises the solar concentrator 204. Thus, in one embodiment, with a focal point of the solar concentrator 204 proximate the hot heat exchanger 206a, a relatively high temperature may be achieved at the primary heat engine 202a. As illustrated, the primary heat engine 202a may be coupled to the solar concentrator 204 by a support beam 212. In this embodiment, the primary heat engine 202a may be fixedly coupled to and be configured to move with the solar concentrator 204 while it tracks the sun. The cold heat exchanger 208a of the primary heat engine 202a may be thermally coupled to the heat transfer loop 210.

The heat transfer loop 210 may have any of a variety of configurations for transferring heat from the cold heat exchanger 208a to the hot heat exchanger 206b of the secondary heat engine 202b. In one embodiment, the heat transfer loop 210 may be carried at least in part by a solar concentrator tower 214. The heat transfer loop 210 may comprise piping or other structures configured to carry a heat transfer fluid between the cold heat exchanger 208a and the hot heat exchanger 206b. In one embodiment, the heat transfer fluid may comprise molten salt. In other embodiments, other fluids with a high heat capacity may be used. In still other embodiments, the heat transfer loop 210 may comprise a heat pipe system.

As illustrated, the secondary heat engine 202b may be mounted to the solar concentrator tower 214 to a rear of the solar concentrator 204. In such an embodiment, during operation, the secondary heat engine 202b may be positioned in a shadow cast by the solar concentrator 204, thereby keeping the cold heat exchanger 208b relatively cool. In addition, the secondary heat engine 202b may act as a counterweight to the primary heat engine 202a, thereby helping to balance the solar concentrator tower 214. In other embodiments, the secondary heat engine 202b may be mounted at other locations on the solar concentrator tower 214. In one embodiment, the cold heat exchanger 208b may include a plurality of cooling fins, or other cooling structures for improving the cooling efficiency of the secondary heat engine 202b.

In one embodiment, using two separate heat engines 202a, 202b instead of a single larger engine may provide a number of benefits. For example, a mass of a generator of the primary heat engine 202a may be relatively small compared to a generator for a single larger engine, and thus, the primary heat engine 202a mounted proximate a focal point of the solar concentrator 204 may be relatively light and small. In addition, when manufactured in volume, the two separate engines 202a, 202b may have costs substantially similar to those of a single larger engine. Yet another advantage of the two engines 202 coupled in series may be that the relatively large cooling structure found at the cold heat exchanger 208b of the secondary heat engine 202b need not be mounted near the focal point of the solar concentrator 204.

Description of another Example Power Generation System

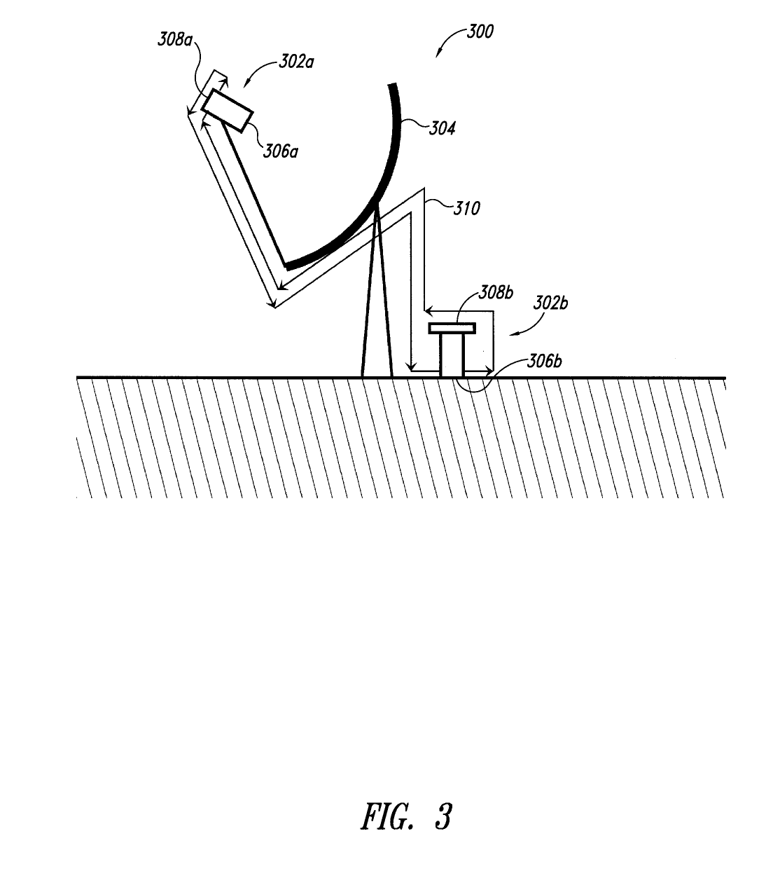

FIG. 3 is a schematic view of yet another exemplary power generation system 300 including a primary heat engine 302a and a secondary heat engine 302b. As illustrated, the power generation system 300 includes a solar concentrator 304 for focusing incident sunlight onto a hot heat exchanger 306a of the primary heat engine 302a. A cold heat exchanger 308a of the primary heat engine 302a may, in turn, be thermally coupled with a hot heat exchanger 306b of the secondary heat engine 302b via a heat transfer loop 310. A cold heat exchanger 308b of the secondary heat engine 302b may be configured to reject waste heat to the ambient environment. Many of the components of the power generation system 300 are configured similarly to the components described above with reference to the power generation system 200. However, as illustrated, the secondary heat engine 302b is positioned differently.

In one embodiment, as illustrated, the secondary heat engine 302b may be positioned on the ground near the solar concentrator 304. In such an embodiment, the secondary heat engine 302b, like the secondary heat engine 202b, may often be positioned in a shadow cast by the solar concentrator 304 during operation, thereby keeping the cold heat exchanger 308b relatively cool. The secondary heat engine 302b may also be mounted such that it does not track the sun with the solar concentrator 304.

### Description of Another Example Power Generation System

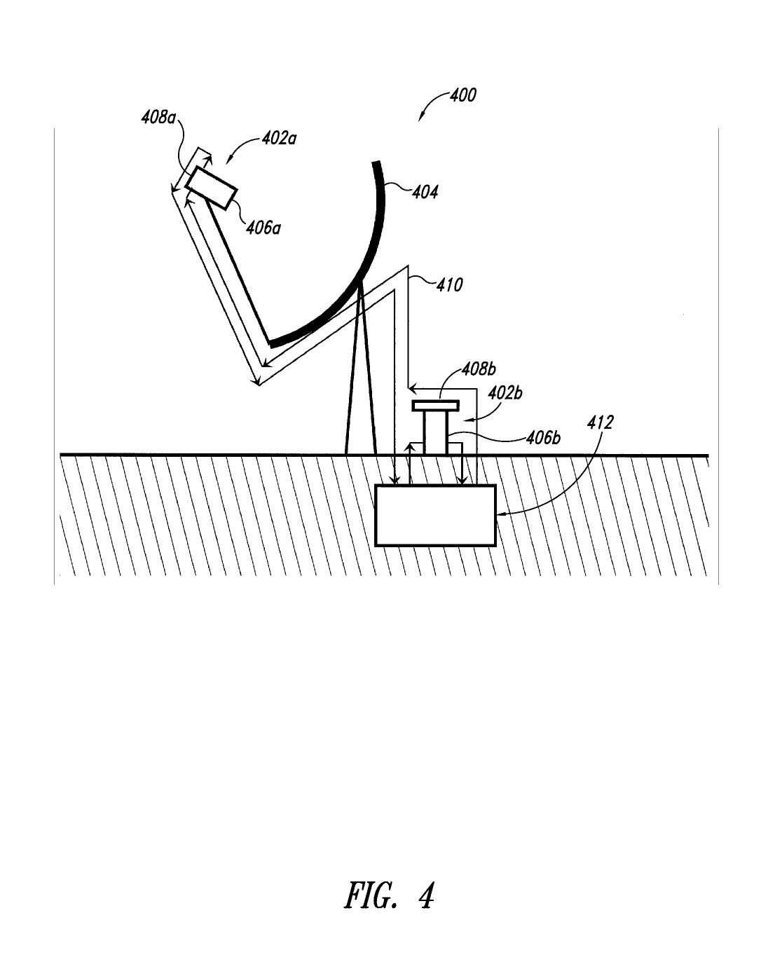

FIG. 4 is a schematic view of yet another exemplary power generation system 400 including a primary heat engine 402a and a secondary heat engine 402b. As illustrated, the power generation system 400 includes a solar concentrator 404 for focusing incident sunlight onto a hot heat exchanger 406a of the primary heat engine 402a. A cold heat exchanger 408a of the primary heat engine 402a may, in turn, be thermally coupled with a hot heat exchanger 406b of the secondary heat engine 402b via a heat transfer loop 410. A cold heat exchanger 408b of the secondary heat engine 402b may be configured to reject waste heat to the ambient environment. Many of the components of the power generation system 400 are configured similarly to the components described above with reference to the power generation system 200.

As illustrated, however, the power generation system 400 may further include a thermal energy storage system 412. The thermal energy storage system 412 may be thermally coupled to the cold heat exchanger 408a of the primary heat engine 402a. For example, as illustrated, the thermal energy storage system 412 may be thermally coupled between the cold heat exchanger 408a and the hot heat exchanger 406b via the heat transfer loop 410. Thus, the thermal energy storage system 412 may be configured to provide thermal energy to the hot heat exchanger 406b of the secondary heat engine 402b.

The thermal energy storage system 412 may be indirectly thermally coupled to the primary heat engine 402a and/or the secondary heat engine 402b. For example, in one embodiment, the thermal energy storage system 412 may be thermally coupled to the cold heat exchanger 408a of the primary heat engine 402a via at least one additional heat engine (not shown). In yet another embodiment, the thermal energy storage system 412 may be thermally coupled to the hot heat exchanger 408b of the secondary heat engine 402b via at least one additional heat engine (not shown).

The thermal energy storage system 412 may comprise any of a variety of structures configured to store thermal energy. In one embodiment, the thermal energy storage system 412 may be configured to store a liquid at an intermediate temperature. For example, in one embodiment, the thermal energy storage system 412 may comprise a reservoir for heat transfer fluid from the heat transfer loop 410. This reservoir may be heavily insulated to lessen thermal energy losses. In such an embodiment, the thermal energy storage system 412 may be understood to store the thermal energy as sensible heat. In other embodiments, the thermal energy storage system 412 may store thermal energy as latent heat (e.g., as a phase change of a material at approximately the intermediate temperature). In still other embodiments, other mechanisms, structures and/or materials for storing thermal energy may be employed.

In one embodiment, the thermal energy storage system 412 may provide a mechanism for decoupling electricity generation from the hours of productive sunlight. That is, the primary heat engine 402a may produce electricity from the sunlight and may then provide waste heat to the thermal energy storage system 412 via the heat transfer loop 410. However, the thermal energy storage system 412 can then deliver the thermal energy stored therein to the secondary heat engine 402b at a later time, and may even store the thermal energy until the primary heat engine 402a is no longer operating. This thermal energy storage thereby allows greater flexibility in matching supply to demand, and may be referred to as dispatchable power.

In another embodiment, the power generation system 400 may further include a secondary heat source (not shown). This secondary heat source may comprise any of a variety of heat sources. In one embodiment, the secondary heat source may enable the power generation system 400 to meet electricity demands when the solar concentrator 404 is not producing sufficient heat at the hot heat exchanger 406a. The secondary heat source may be positioned proximate the thermal energy storage system 412 and may be configured to directly warm the heat transfer fluid stored within the thermal energy storage system 412. For example, the secondary heat source may comprise a combustible fuel (e.g., natural gas) that is used to generate heat at or near the thermal energy storage system 412. In other embodiments, the secondary heat source may be positioned at other locations within the power generation system 400. For example, the secondary heat source may be positioned proximate the hot heat exchanger 406b of the secondary heat engine 402b in order to drive the secondary heat engine 402b independently of the heat from the thermal energy storage system 412. Other embodiments are also possible.

In one embodiment, the use of two separate heat engines 402a, 402b facilitates the addition of the thermal energy storage system 412 while maintaining a relatively high system efficiency. The primary heat engine 402a may be configured to operate between a hot temperature set at the engine material limits and an intermediate temperature, and the secondary heat engine 402b may be configured to operate between approximately this intermediate temperature and a low temperature. As described with reference to FIG. 1, the combined output of the two heat engines 402a, 402b may be substantially equivalent in efficiency to a single larger heat engine mounted at the focus of the solar concentrator 404. In addition, the power generation system 400 may enable thermal storage at approximately the intermediate temperature.

### Description of Another Example Power Generation System

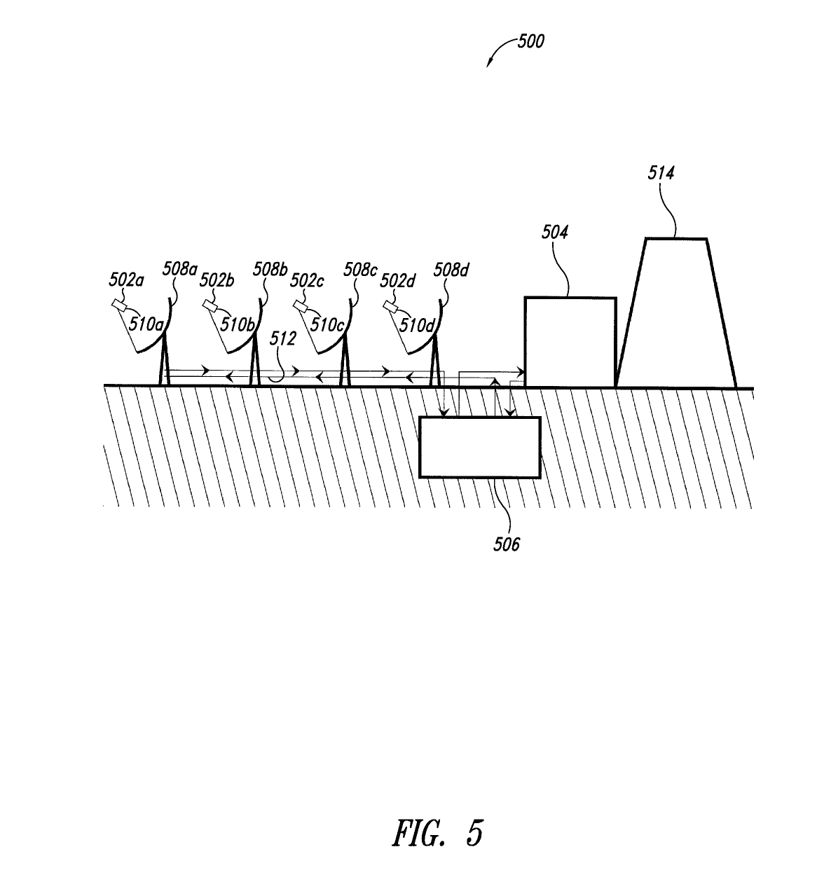

FIG. 5 is a schematic view of yet another exemplary power generation system 500 including a plurality of primary heat engines 502a-d (collectively 502), a secondary heat engine 504, and a thermal energy storage system 506. As illustrated, the power generation system 500 includes a plurality of solar concentrators 508a-d (collectively 508) for focusing incident sunlight onto respective hot heat exchangers 510a-d (collectively 510) of the primary heat engines 502a-d. Cold heat exchangers (not shown) of the primary heat engines 502 may, in turn, be thermally coupled with a hot heat exchanger of the secondary heat engine 504 via a heat transfer loop 512. A cold heat exchanger 514 of the secondary heat engine 504 may be configured to reject waste heat from the secondary heat engine 504 to the ambient environment. Many of the components of the power generation system 500 are configured similarly to the components described above with reference to the power generation system 200.

In one embodiment, the primary heat engines 502 may be coupled in parallel. The waste heat from all of these primary heat engines 502 may be directed to the thermal energy storage system 506. The secondary heat engine 504 may then receive this thermal energy at a hot heat exchanger and generate electricity. Thus, the secondary heat engine 504 may be thermally coupled to the plurality of primary heat engines 502 via the thermal energy storage system 506.

In one embodiment, the secondary heat engine 504 may be located apart from all of the primary heat engines 502, and may represent a larger and differently configured heat engine than the primary heat engines 502. For example, in one embodiment, the secondary heat engine 504 may comprise a conventional steam turbine for generating electricity, while the primary heat engines 502 comprise individual Stirling engines. In such an embodiment, the cold heat exchanger 514 may comprise a cooling tower for the secondary heat engine 504.

As described above with reference to the power generation system 400, the power generation system 500 may further include a secondary heat source (not shown) to enable the system 500 to meet electricity demands even when the solar concentrators 508 are not producing sufficient heat. In other embodiments, the secondary heat source may be used to augment the amount of electricity generated by the power generation system 500. In one embodiment, the secondary heat source may be positioned near the thermal energy storage system 506 and may be configured to directly warm the heat transfer fluid stored therein.

The power generation system 500 may be theoretically compared to a hypothetical parabolic trough system having the same total solar collector area. With the same total solar collector area, the total solar input power for both the power generation system 500 and the hypothetical parabolic trough system may be approximately equal. To facilitate the comparison, an intermediate temperature for the heat transfer loop 512 may be assumed to be equal to a temperature of a heat transfer fluid of the parabolic trough system. The hypothetical parabolic trough system may also be assumed to include a thermal energy storage system that operates similarly to the thermal energy storage system 506. Finally, the secondary heat engine 504 of the power generation system 500 may comprise a steam turbine that is identical to a centralized steam turbine used with the hypothetical parabolic trough system.

Comparing the hypothetical parabolic trough system with the power generation system 500, it is believed that the primary heat engines 502 may enable some of the heat generated at the power generation system 500 to be processed at higher temperatures, which may thereby increase the efficiency of the power generation system 500 relative to the hypothetical parabolic trough system. It is believed that these efficiency gains may be realized while the total cost of the power generation system 500 may be only incrementally increased relative to the hypothetical parabolic trough system, as these systems share many similar elements. It may be understood that, in some embodiments, the electrical power generated by the primary heat engines 502 may not be dispatchable.

In some embodiments, the primary heat engines 502 may reduce the heat input to the secondary heat engine 504 by approximately an amount of the heat converted into mechanical motion at the primary heat engines 502. In such embodiments, the secondary heat engine 504 may have a lower power output than the centralized steam turbine of the hypothetical parabolic trough system. However, it is believed that the amount by which the heat input to the secondary heat engine 504 is reduced may be efficiently converted to mechanical motion and, in turn, to electricity by the primary heat engines 502. These efficiency gains may at least in part compensate for a reduction in output from the secondary heat engine 504.

In one exemplary comparison, the hypothetical parabolic trough system may be assumed to include a heat transfer liquid at 663K and may operate at an overall efficiency of 18%. Meanwhile, in one embodiment, the primary heat engines 502 may comprise Stirling engines operating between a high temperature of 1050K and an approximate intermediate temperature of 663K. In one embodiment, these primary heat engines 502 may operate at approximately 60% of Carnot efficiency, and may have a mechanical to electrical conversion efficiency of approximately 90%. In such an embodiment, it is believed that the primary heat engines 502 may process the solar input power to generate electricity with approximately 20% efficiency, leaving the remaining approximately 80% of the solar input power for power generation by the secondary heat engine 504. It is further believed that the output of the secondary heat engine 504 may be reduced to approximately 14% of the total solar input power in comparison to the 18% realized by the hypothetical parabolic trough system. However, it is believed that a total electrical output of the power generation system 500 may be approximately 34% of the total solar input power. The reduction in the output from the secondary heat engine 504 may be attributed to the approximately 20% lower heat input to the secondary heat engine 504. Thus, in one embodiment, it is believed that a size of the secondary heat engine 504 may be reduced, which may at least in part offset a cost of the primary heat engines 502.

### Description of an Exemplary Method for Generating Power

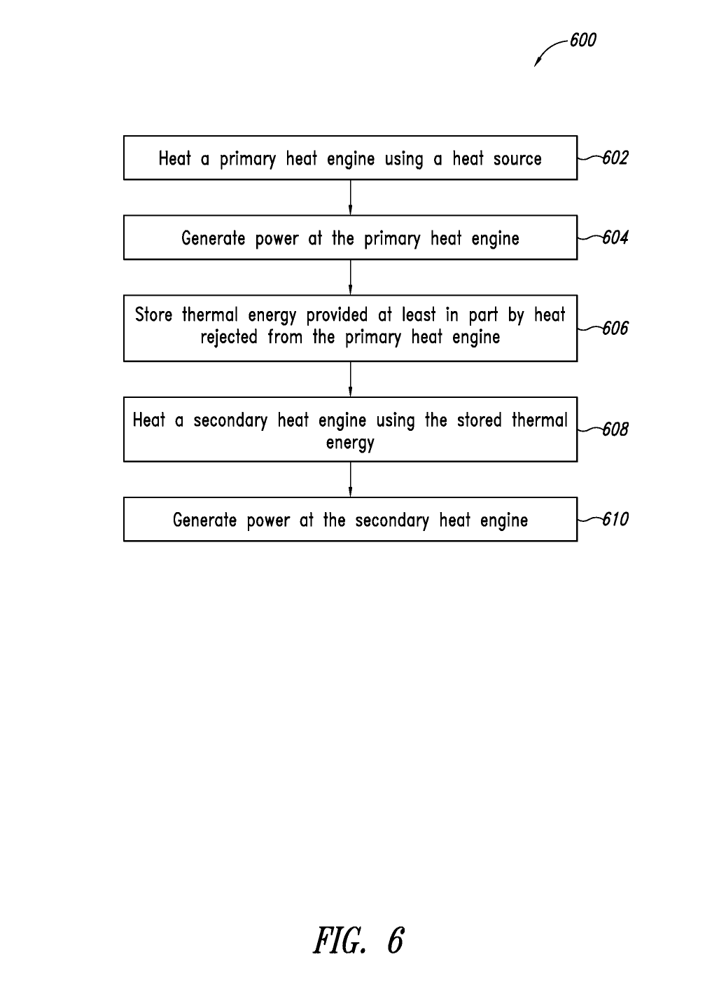

FIG. 6 illustrates a flow diagram for a method 600 of generating power, according to one embodiment. This method 600 will be discussed in the context of the power generation system 400 of FIG. 4. However, it may be understood that the acts disclosed herein may be executed using a variety of different power generation systems, in accordance with the described method.

The method begins at 602, when a primary heat engine 402a is heated using a heat source. As described above, the primary heat engine 402a may be heated using any of a variety of heat sources. As illustrated in FIG. 4, a solar concentrator 404 may be used to focus sunlight onto a hot heat exchanger 406a of the primary heat engine 402a. In some embodiments (such as in geothermal systems), the primary heat engine 402a need simply be positioned in the correct location to achieve heating, while, in other embodiments, other acts may be performed (e.g., re-positioning, focusing, combusting, etc.).

At 604, power is generated at the primary heat engine 402a. The primary heat engine 402a may be configured to generate power in any of a variety of ways. Any of a variety of structures for converting the mechanical motion produced by the primary heat engine 402a into electrical power may be used.

At 606, thermal energy provided at least in part by heat rejected from the primary heat engine 402a is stored. In one embodiment, the thermal energy may be stored in a thermal energy storage system 412 for later use. For example, the thermal energy storage system 412 may store a heat transfer fluid. The thermal energy storage system 412 may, in turn, be thermally coupled to a cold heat exchanger 408a of the primary heat engine 402a (e.g., via a heat transfer loop 410 carrying the heat transfer fluid) in order to receive at least some of the heat rejected from the primary heat engine 402a.

At 608, a secondary heat engine 402b is heated using the stored thermal energy. As illustrated in FIG. 4, the secondary heat engine 402b may be thermally coupled to the thermal energy storage system 412 via the heat transfer loop 410. For example, a hot heat exchanger 406b of the secondary heat engine may receive a heat transfer fluid from the thermal energy storage system 412.

In some embodiments, as described above, the thermal energy need not be stored in accordance with act 606. For example, act 606 may be omitted, and the secondary heat engine may be heated using thermal energy provided at least in part by heat rejected from the primary heat engine, as illustrated in FIGS. 2 and 3.

At act 610, power is generated at the secondary heat engine 402b. The secondary heat engine 402b may be configured to generate power in any of a variety of ways. In one embodiment, the secondary heat engine 402b need not generate power in the same manner that power is generated at the primary heat engine 402a. For example, the secondary heat engine 402b may comprise a steam turbine, while the primary heat engine 402a comprises a Stirling engine.

### Description of Another Exemplary Method for Generating Power

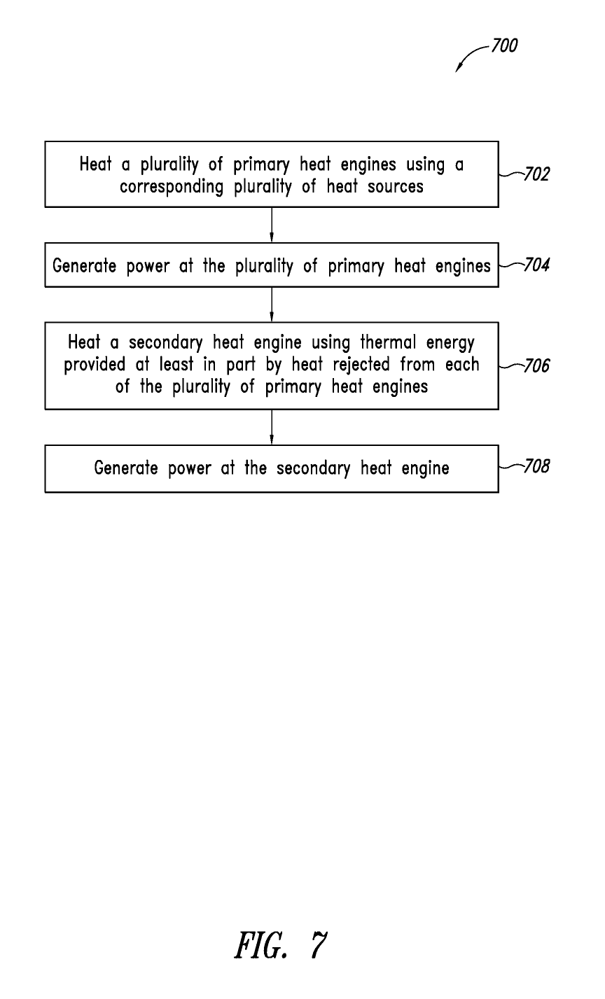

FIG. 7 illustrates a flow diagram for another method 700 of generating power, according to one embodiment. This method 700 will be discussed in the context of the power generation system 500 of FIG. 5. However, it may be understood that the acts disclosed herein may be executed using a variety of different power generation systems, in accordance with the described method.

The method begins at 702, when a plurality of primary heat engines 502 are heated using a corresponding plurality of heat sources 508. The primary heat engines 502 may be heated using any of a variety of heat sources. In one embodiment, a solar concentrator 508 corresponding to each primary heat engine 502 may be used to focus sunlight onto a hot heat exchanger 510 of the primary heat engine 502.

At 704, power is generated at the plurality of primary heat engines 502. The primary heat engines 502 may be configured to generate power in any of a variety of ways. Any of a variety of structures for converting the mechanical motion produced by the primary heat engines 502 into electrical power may be used.

At 706, a secondary heat engine 504 is heated using thermal energy provided at least in part by heat rejected from each of the plurality of primary heat engines 502. In one embodiment, the heat rejected from each of the plurality of primary heat engines 502 may be provided directly to the secondary heat engine 504 (e.g., via a heat transfer loop 512). In another embodiment, the thermal energy may first be stored in a thermal energy storage system 512 before being provided to the secondary heat engine 504. For example, the thermal energy storage system 512 may store a heat transfer fluid.

At 708, power is generated at the secondary heat engine 504. The secondary heat engine 504 may be configured to generate power in any of a variety of ways. In one embodiment, the secondary heat engine 504 need not generate power in the same manner that power is generated at the primary heat engines 502. For example, the secondary heat engine 504 may comprise a steam turbine, while the primary heat engines 502 comprise a plurality of Stirling engines.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

I claim:

1. A power generation system comprising:
a heat source;
at least one primary heat engine operating between a high temperature generated by the heat source and an intermediate temperature;
a thermal energy storage system thermally coupled to the at least one primary heat engine, the thermal energy storage system configured to store thermal energy; and
at least one secondary heat engine thermally coupled to the thermal energy storage system, and operating between approximately the intermediate temperature and a low temperature for rejection of waste heat.

2. The power generation system of claim 1, wherein the thermal energy storage system is further configured to store the thermal energy as a phase change of a material at approximately the intermediate temperature.

3. The power generation system of claim 1, wherein the heat source comprises one or more mirrors or lenses configured to concentrate sunlight onto the at least one primary heat engine.

4. The power generation system of claim 1, further comprising:
a heat transfer loop extending between the at least one primary heat engine, the thermal energy storage system, and the at least one secondary heat engine, the heat transfer loop configured to transfer heat between the at least one primary heat engine, the thermal energy storage system and the at least one secondary heat engine.

5. The power generation system of claim 1, further comprising a solar concentrator, wherein the at least one primary heat engine is mounted proximate a focus of the solar concentrator, and the at least one secondary heat engine is mounted to a rear of the solar concentrator.

6. The power generation system of claim 5, wherein, during operation, the at least one secondary heat engine is positioned in a shadow of the solar concentrator.

7. The power generation system of claim 1, further comprising a solar concentrator configured to track the sun, wherein the at least one primary heat engine is mounted proximate a focus of the solar concentrator, and the at least one secondary heat engine is mounted such that the at least one secondary heat engine does not track the sun with the solar concentrator.

8. A power generation system comprising:
a heat source;
a primary heat engine having a hot heat exchanger thermally coupled to the heat source, and a cold heat exchanger;
a thermal energy storage system thermally coupled to the cold heat exchanger of the primary heat engine; and
a secondary heat engine having a hot heat exchanger thermally coupled to the thermal energy storage system, and a cold heat exchanger configured to reject waste heat.

9. The power generation system of claim 8, wherein the thermal energy storage system is thermally coupled to the cold heat exchanger of the primary heat engine via at least one additional heat engine.

10. The power generation system of claim 8, wherein the hot heat exchanger of the secondary heat engine is thermally coupled to the thermal energy storage system via at least one additional heat engine.

11. The power generation system of claim 8, wherein the heat source comprises one or more mirrors or lenses configured to concentrate sunlight onto the hot heat exchanger of the primary heat engine.

12. The power generation system of claim 11, wherein the primary heat engine is mounted proximate a focus of a solar concentrator including the one or more mirrors or lenses, and the secondary heat engine is mounted to a rear of the solar concentrator.

13. The power generation system of claim 8, further comprising:
a heat transfer loop extending between the primary heat engine, the thermal energy storage system and the secondary heat engine, the heat transfer loop configured to transfer heat for thermally coupling the primary heat engine, the thermal energy storage system, and the secondary heat engine.

14. The power generation system of claim 8, wherein the primary heat engine comprises a Stirling engine.

15. The power generation system of claim 8, wherein the secondary heat engine comprises a Stirling engine.

16. The power generation system of claim 8, further comprising:
a second heat source; and
a second primary heat engine having a hot heat exchanger thermally coupled to the second heat source, and a cold heat exchanger;
wherein the thermal energy storage system is further thermally coupled to the cold heat exchanger of the second primary heat engine, such that the secondary heat engine is thermally coupled to both the primary heat engine and the second primary heat engine via the thermal energy storage system.

17. A power generation system comprising:
a plurality of heat sources;
a plurality of primary heat engines, each primary heat engine having a hot heat exchanger thermally coupled to a corresponding one of the plurality of heat sources, and a cold heat exchanger; and
a secondary heat engine having a hot heat exchanger thermally coupled to the plurality of primary heat engines, and a cold heat exchanger configured to reject waste heat.

18. The power generation system of claim 17, wherein each of the plurality of heat sources comprises one or more mirrors or lenses configured to concentrate sunlight onto the hot heat exchanger of a corresponding one of the plurality of primary heat engines.

19. The power generation system of claim 18, wherein each of the plurality of primary heat engines is mounted proximate a focus of a corresponding solar concentrator, and the secondary heat engine is located apart from all of the plurality of primary heat engines.

20. The power generation system of claim 17, further comprising:
a thermal energy storage system thermally coupled between the cold heat exchanger of each of the plurality of primary heat engines, and the hot heat exchanger of the secondary heat engine.

21. A method of generating power, comprising:
heating a primary heat engine using a heat source;
generating power at the primary heat engine;
storing thermal energy provided at least in part by heat rejected from the primary heat engine;
heating a secondary heat engine using the stored thermal energy; and
generating power at the secondary heat engine.

22. The method of claim 21, wherein heating the primary heat engine comprises positioning one or more mirrors or lenses to concentrate sunlight onto a hot heat exchanger of the primary heat engine.

23. The method of claim 21, further comprising:
transferring the heat rejected from the primary heat engine to a thermal energy storage system via a heat transfer loop.

24. A method of generating power, comprising:
heating a plurality of primary heat engines using a corresponding plurality of heat sources;
generating power at the plurality of primary heat engines;
heating a secondary heat engine using thermal energy provided at least in part by heat rejected from each of the plurality of primary heat engines; and
generating power at the secondary heat engine.

25. The method of claim 24, wherein heating the plurality of primary heat engines comprises positioning one or more mirrors or lenses to concentrate sunlight onto hot heat exchangers of the plurality of primary heat engines.

26. The method of claim 24, further comprising:
storing the thermal energy provided at least in part by the heat rejected from the plurality of primary heat engines;
wherein heating the secondary heat engine further comprises heating the secondary heat engine using the stored thermal energy.

27. The method of claim 26, further comprising:
transferring the heat rejected from the plurality of primary heat engines to a thermal energy storage system via a heat transfer loop.
